(19) United States
(12) Patent Application Publication
(10) Pub. No.: US 2018/0086426 A1
(43) Pub. Date: Mar. 29, 2018

(54) MARINE PROPULSION SYSTEM

(71) Applicant: SCHOTTEL GMBH, D-56322 SPAY/RHEIN (DE)

(72) Inventors: Volker HÖFER, Boppard (DE); Jörg SHEID, Mendig (DE)

(21) Appl. No.: 15/567,522

(22) PCT Filed: May 6, 2016
(86) PCT No.: PCT/EP2016/060151

§ 371 Date: Oct. 18, 2017

(30) Foreign Application Priority Data
May 7, 2015 (DE) 10 2015 107 165.7

(51) Int. Cl. B63H 21/17; B63H 23/04; B63H 23/30; H02K 7/14; H02K 7/116

(52) U.S. Cl. CPC B63H 21/17; B63H 23/04; B63H 23/30; B63H 2023/0283; H02K 7/1163; B63B 2755/00; H02K 7/14

(57) ABSTRACT

A marine propulsion system having an upper housing part, a pod, and a shank extending between the upper housing part and the pod. An underwater transmission having an input shaft and an output shaft is arranged in the pod and the input shaft is connected to a drive shaft that extends through the shank and is driven by an electric motor. The electric motor is mounted inside the shank and that surrounds the drive shaft.

### BACKGROUND OF THE INVENTION

### Field of the Invention

This invention relates to a marine propulsion system including an upper housing part, a pod, and a shank extending between the upper housing part and the pod, an underwater transmission having an input shaft and an output shaft is arranged in the pod and the input shaft is connected to a drive shaft that extends through the shank and is driven by an electric motor, and the electric motor is positioned inside the shank and surrounding the drive shaft.

### Discussion of Related Art

Marine propulsion systems of this type are known, for example, from PCT International Publication WO 2010/100 092 A2 and are used to convert the drive energy exerted on the drive shaft into propulsion force by a propeller mounted on the output shaft.

In another marine propulsion system of the type disclosed by German Patent Reference DE 10 2010 055 778 A1, an electric motor positioned in the region of the upper housing part above the shank is connected to the drive shaft and, via the underwater transmission contained in the pod, drives the output shaft and finally, the propeller that is mounted on this output shaft. A marine propulsion system of this type usually functions according to the so-called diesel-electric principle, such as an internal combustion engine inside the vessel generating electrical energy that is supplied to the electric motor.

One disadvantage of the known prior art is the amount of space required by the electric motor positioned in the upper housing part, which forms the highest point of the propulsion system and requires large amounts of lubricant, because both the pod, which contains the underwater transmission, and the shank must be filled with oil. This leads to additional problems such as high churning losses of the gears rotating in the oil bath and poor service accessibility.

Another possibility for integrating an electric motor into a marine propulsion system, in particular a rudder propeller, is formed by POD systems in which the driving electric motor is built into the pod. Such a propulsion system, however, requires a correspondingly high-volume pod, which is accompanied by fluidic disadvantages, and furthermore, such a propulsion system is difficult to maintain because in a maintenance situation, the maintenance on the motor cannot easily be carried out from the hull.

### SUMMARY OF THE INVENTION

One object of this invention is to provide a marine propulsion system of the type mentioned above but which avoids the disadvantages of the prior art.

In order to attain this object, this invention includes an electric motor, which is positioned inside the shank and surrounds the drive shaft, connected to the drive shaft via a reduction gear, which is positioned in the upper housing part and is embodied in the form of a planetary gear. The provision of a reduction gear makes it possible to provide a motor with slim dimensions, which has comparatively less torque than before, but is still able to produce the required driving torques through the interposition of the reduction gear. In addition to the significantly reduced acquisition and production costs of such reduced-dimension electric motors, they can also be accommodated in a marine propulsion system shank that is relatively slim, which is in turn accompanied by fluidic advantages. The reduction gear, which according to one embodiment of this invention is formed as a planetary gear, because it is positioned in the upper housing part and thus above the electric motor, is easily accessible for maintenance purposes and thus operates without significant churning losses because it is forcibly lubricated with lubricant supplied by corresponding supply lines.

The arrangement according to this invention achieves two main advantages. First, the electric motor is integrated into the shank in a particularly space-saving way, for example, it no longer forms the highest point of the marine propulsion system, and the upper housing part can be embodied as correspondingly or relatively smaller. Also, a significant length is available inside the shank so that the electric motor used can be embodied as correspondingly or relatively long, making it possible to reduce the outer diameter thereof, without accepting losses in performance.

Another advantage is that integrating the electric motor into the shank reduces the oil volume required in the marine propulsion system because a large part of the previously oil-filled space is occupied by the electric motor.

According to one embodiment of this invention, the electric motor even extends beyond the shank into the upper housing part, which is still required for fixing the marine propulsion system according to this invention in the hull.

The marine propulsion system according to this invention can be a rudder propeller, which is embodied with an adjusting drive for rotating the pod and possibly also the shank connected to it around a vertical axis. In this case, the adjusting drive is advantageously positioned in the vicinity of or near the upper housing part and forms the highest point of the marine propulsion system according to this invention. The overall height of the adjusting drive can be further reduced by an angled arrangement of the adjusting motors.

In addition to the provision of a single reduction gear, it is also possible to provide additional reduction gears, preferably in the upper housing part, especially in the form of planetary gears such as inside the pod, so that total gear ratios of i>20 can be produced.

It is also possible to connect the drive shaft to an above-water transmission via a switchable clutch and for the drive shaft to be driven by it so that in addition to the electric motor, an additional internal combustion engine, for example, mounted in the vessel, can transmit drive forces to the output shaft and it is thus possible to achieve a particularly space-saving hybrid drive.

### BRIEF DESCRIPTION OF THE DRAWINGS

Other embodiments and details of this invention are explained in greater detail in view of embodiments shown in the drawings, wherein:

FIG. 1 is a schematic side view of a first embodiment of a marine propulsion system according to this invention;

FIG. 2 shows a schematic side view of a second embodiment of this invention;

FIG. 3 shows a schematic side view of a cooling of a first embodiment of this invention;

FIG. 4 shows a schematic side view of a cooling of a second embodiment of this invention.

### DETAILED DESCRIPTION OF THE INVENTION

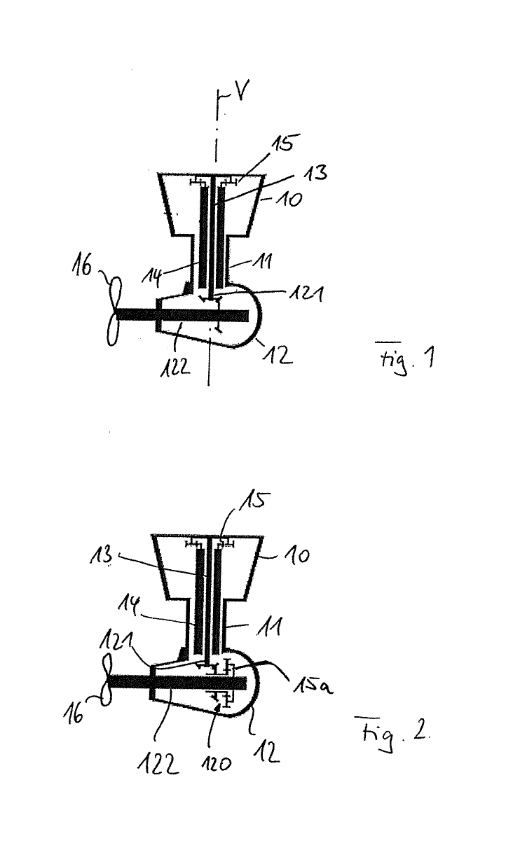

FIG. 1 shows a marine propulsion system according to a first embodiment, which is a rudder propeller that can be rotated around a vertical axis V by adjusting drives that are not shown, but are intrinsically known to those skilled in the art.

The marine propulsion system comprises an upper housing part 10, a pod 12, and a shank 11 extending between the upper housing part 10 and the pod 12. Whereas the upper housing part 10 is installed in stationary fashion in a hull that is not shown here, the shank 11 and the pod 12 can be pivoted around the axis V by the adjusting drive in order, in addition to propulsion, to also produce a control impulse for the watercraft that is equipped with it.

The pod 12 accommodates an underwater transmission 120, which has an input shaft 121 and an output shaft 122 that are arranged at a 90° angle with respect to each other. For example, the horizontally extending output shaft 122 supports a propeller labeled with the reference numeral 16 at one of its ends that extends out from the pod 12.

The input shaft 121 of the underwater transmission 120 is connected to a drive shaft 13, which is driven by an electric motor 14. The electric motor 14 draws its energy, for example, from suitable energy storage devices onboard the vessel or from an internal combustion engine in order to implement a diesel-electric drive.

In order to achieve a particularly compact propulsion system, the electric motor 14 is positioned inside the shank 11 and surrounds the drive shaft, with the electric motor 14 extending into the upper housing part 10.

The selected positioning of the electric motor 14 inside the shank 11, possibly extending into the upper housing part 10, achieves a particularly compact propulsion system, which can be easily integrated into a watercraft and requires only an extremely small amount of space. For this purpose, usually only the upper housing part 10 is accommodated inside the hull, whereas the shank 11 and the pod 12 protrude from the underside of the hull and are positioned underwater.

The upper housing part 10 thus accommodates only a part of the electric motor 14 and the adjusting drive, whereas the remaining part of the electric motor 14 is accommodated inside the shank.

Because the electric motor 14 is positioned inside the shank 11 and extends partially into the upper housing part 10, it is possible for a very long embodiment of the electric motor 14 to be integrated into the propulsion system, permitting a significant reduction in the outer diameter of the latter. The shank 11 thus achieves a cross-section that is advantageous from a flow standpoint despite the fact that it accommodates the electric motor 14.

The drive shaft 13 extends all the way through the electric motor 14 and is coupled to the input shaft 121 of the underwater transmission 122. The electric motor 14 acts on the drive shaft 13 via a reduction gear in the form of a planetary gear accommodated in the upper housing part 10. This planetary gear is driven by the electric motor 14 via a hollow shaft through which the drive shaft 13 extends. By providing such a reduction gear, only a slight drive torque is required from the electric motor 14 so that the dimensions of the electric motor 14 can be further reduced and it can also be accommodated in a shank 14 that is of only small dimensions.

In the embodiment according to FIG. 2, it is also possible to provide additional reduction gears, for example, in the vicinity of or near the pod 12, as indicated by the reference numeral 15a. For example, the output shaft 122 can be connected to a reduction gear 15a embodied in the form of a planetary gear and can be driven via the latter. In this way, it is possible to implement total gear ratios of i>20. By selectively adapting the gear ratios of the planetary gears 15, 15a, a very small ring gear can be used in the underwater transmission 120, which requires very advantageous L/D ratios.

In all of the embodiments explained above, the required oil volume in the marine propulsion system is reduced because a large part of the available space is already taken up by the electric motor 14 in the shank 11 and in the upper housing part 10. Depending on the embodiment of the marine propulsion system, it is possible to reduce the oil volume to only the underwater transmission inside the pod 12.

Naturally, the above-explained marine propulsion systems cannot only be installed in a stationary fashion in a hull, but can also be used in the form of marine propulsion systems that can be extended along the vertical axis V. Here, too, the positioning of the electric motor 14 inside the shank in the way proposed according to this invention offers significant advantages.

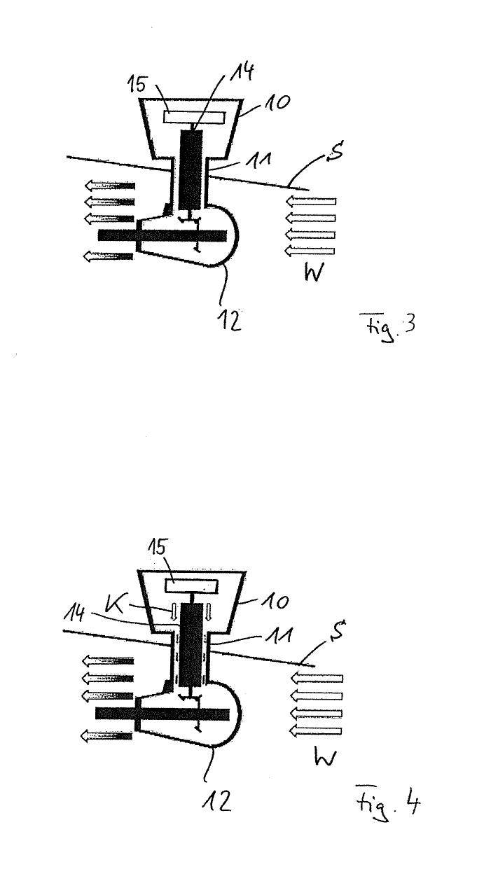

FIGS. 3 and 4 show two embodiments according to FIG. 1 of how the underwater transmission accommodated inside the pod 12 and the electric motor 14 can be cooled.

According to the exemplary embodiment shown in FIG. 3, the cooling of the propulsion system components is carried out exclusively by the water W flowing past underneath the hull S, whereas in the exemplary embodiment according to FIG. 4, an additional coolant circuit K is provided inside the marine propulsion system in addition to the cooling provided by the water W flowing past.

1. A marine propulsion system comprising an upper housing part (10), a pod (12), and a shank (11) extending between the upper housing part (10) and the pod (12); an underwater transmission (120) having an input shaft (121) and an output shaft (122) arranged in the pod (12) and the input shaft (121) connected to a drive shaft (13) extending through the shank (11) and driven by an electric motor (14), the electric motor (14) being positioned inside the shank (11) and surrounding the drive shaft (13), and the drive shaft (13) connected to the electric motor (14) by a reduction gear (15) and the reduction gear (15) accommodated in the upper housing part.

2. The marine propulsion system according to claim 1, wherein the electric motor (14) extends beyond the shank into the upper housing part (10).

3. The marine propulsion system according claim 2, wherein the drive shaft (13) forms or is connected to the rotor of the electric motor (14).

4. The marine propulsion system according to claim 3, wherein the reduction gear (15) is a planetary gear.

5. The marine propulsion system according to claim 4, wherein the marine propulsion system is embodied as a rudder propeller with an adjusting drive for rotating the pod (12) around a vertical axis (V).

6. The marine propulsion system according to claim 5, wherein the marine propulsion system is embodied as a propulsion system that can be extended out from a hull.

7. The marine propulsion system according to claim 6, wherein the drive shaft (13) can be connected by a switchable clutch to an above-water transmission and can be driven.

8. The marine propulsion system according to claim 7, wherein the output shaft (122) is connected to a reduction gear (15a) embodied as a planetary gear.

9. The marine propulsion system according to claim 1, wherein the drive shaft (13) forms or is connected to the rotor of the electric motor (14).

10. The marine propulsion system according to claim 1, wherein the reduction gear (15) is a planetary gear.

11. The marine propulsion system according to claim 1, wherein the marine propulsion system is embodied as a rudder propeller with an adjusting drive for rotating the pod (12) around a vertical axis (V).

12. The marine propulsion system according to claim 1, wherein the marine propulsion system is embodied as a propulsion system that can be extended out from a hull.

13. The marine propulsion system according to claim 1, wherein the drive shaft (13) can be connected by a switchable clutch to an above-water transmission and can be driven.

14. The marine propulsion system according to claim 1, wherein the output shaft (122) is connected to a reduction gear (15a) embodied as a planetary gear.
